(19) United States
(12) Patent Application Publication
(10) Pub. No.: US 2019/0277365 A1
(43) Pub. Date: Sep. 12, 2019

(54) SHOCK ABSORBER

(71) Applicant: KYB Corporation, Tokyo (JP)

(72) Inventors: Naoki KUBOTA, Gifu (JP); Hideaki TAKEUCHI, Gifu (JP)

(73) Assignee: KYB Corporation, Tokyo (JP)

(21) Appl. No.: 16/335,198

(22) PCT Filed: Sep. 15, 2017
(86) PCT No.: PCT/JP2017/033516

§ 371 Date: Mar. 20, 2019

(30) Foreign Application Priority Data
Sep. 20, 2016 (JP) 2016-182855

(51) Int. Cl. F16F 9/36; F16F 9/19; F16J 15/3232

(52) U.S. Cl. CPC F16F 9/362; F16F 2230/30; F16J 15/3232; F16F 9/19

(57) ABSTRACT

A shock absorber includes a cylinder, a piston, a piston rod, and a rod guide provided on an inside end portion of the cylinder so as to support the piston rod to be free to slide, wherein the rod guide includes a retainer attached to an inner peripheral surface of the cylinder so as to face an extension-side chamber, a bearing that supports the piston rod to be free to slide, a main seal provided between the bearing and the retainer, and a seal holder that is provided on a radial direction outer side of the main seal and has an annular recess formed in a surface thereof that opposes the retainer, and a seal holder presses the main seal against an outer peripheral surface of the piston rod upon reception of working oil pressure led into the annular recess from the extension-side chamber.

### TECHNICAL FIELD

The present invention relates to a shock absorber.

### BACKGROUND ART

U.S. Pat. No. 3,837,445A discloses a shock absorber including a cylinder having an operation chamber formed in the interior thereof, an annular rod guide fixed to an upper opening portion of the cylinder, an annular seat provided on the operation chamber side of the rod guide, a rod inserted into the inside of the rod guide and the seat so as to be capable of moving in an axial direction, an annular oil seal held on the inner periphery of the rod guide so as to seal the outer periphery of the rod, and an annular seal holder interposed between the rod guide and the seat so as to be provided on the outer periphery of the oil seal.

### SUMMARY OF INVENTION

In the shock absorber disclosed in U.S. Pat. No. 3,837,445A, when pressure in the operation chamber acts on an end surface of the seal holder through a communicating passage passing through the seal in the axial direction, the seal holder is compressed in the axial direction so as to bulge out in a radial direction. The oil seal is pressed against a piston rod by the seal holder bulging out in the radial direction in this manner, and as a result, a sealing property is secured in the shock absorber. In other words, the oil seal is pressed against the piston rod upon reception of a force generated when the pressure in the operation chamber, which acts in the axial direction, is converted to the radial direction by the deformation of the seal holder.

However, the pressure in the operation chamber is derived from working oil pressure generated during an extension/contraction operation and pressure in a gas chamber that is provided in the cylinder to compensate for volume change in the piston rod during the extension/contraction operation. Hence, when the extension/contraction state of the shock absorber varies, the working oil pressure in the interior thereof and the pressure in the gas chamber also vary, leading to variation in the pressure in the operation chamber. With the shock absorber disclosed in U.S. Pat. No. 3,837,445A, therefore, the pressure acting on the seal holder varies in accordance with the extension/contraction state, and as a result, the force for pressing the oil seal against the piston rod may be insufficient.

An object of the present invention is to improve the sealing property of a shock absorber.

According to one aspect of the present invention, a shock absorber includes: a cylinder in which a working fluid is sealed; a piston provided inside the cylinder to be free to slide, the piston being configured to partition the interior of the cylinder into an extension-side chamber and a contraction-side chamber; a piston rod inserted into the cylinder to be free to move in and out of the cylinder, the piston rod being coupled to the piston; and a rod guide provided on an inside end portion of the cylinder so as to support the piston rod to be free to slide, wherein the rod guide includes: a retainer attached to an inner peripheral surface of the cylinder so as to face the extension-side chamber; a bearing configured to support the piston rod to be free to slide; a main seal provided between the bearing and the retainer; and a seal holder provided on a radial direction outer side of the main seal, the seal holder having a recessed portion formed in a surface thereof that opposes the retainer, and the seal holder presses the main seal against an outer peripheral surface of the piston rod upon reception of working fluid pressure that is led into the recessed portion from the extension-side chamber.

### BRIEF DESCRIPTION OF DRAWINGS

FIG. 1 is a sectional view of a shock absorber according to an embodiment of the present invention.

FIG. 2 is an enlarged sectional view showing a rod guide according to this embodiment of the present invention.

FIG. 3 is a view showing the sectional shape of a main seal according to this embodiment of the present invention in a natural state in which no external force is applied.

FIG. 4 is a view showing the sectional shape of a seal holder according to this embodiment of the present invention in a natural state in which no external force is applied.

FIG. 5 is an enlarged sectional view showing the main seal and the seal holder according to this embodiment of the present invention in a state in which the internal pressure of an extension-side chamber is not exerted thereon.

FIG. 6 is an enlarged sectional view showing a rod guide according to a comparative example of the present invention.

### DESCRIPTION OF EMBODIMENTS

An embodiment of the present invention will be described below with reference to the attached figures.

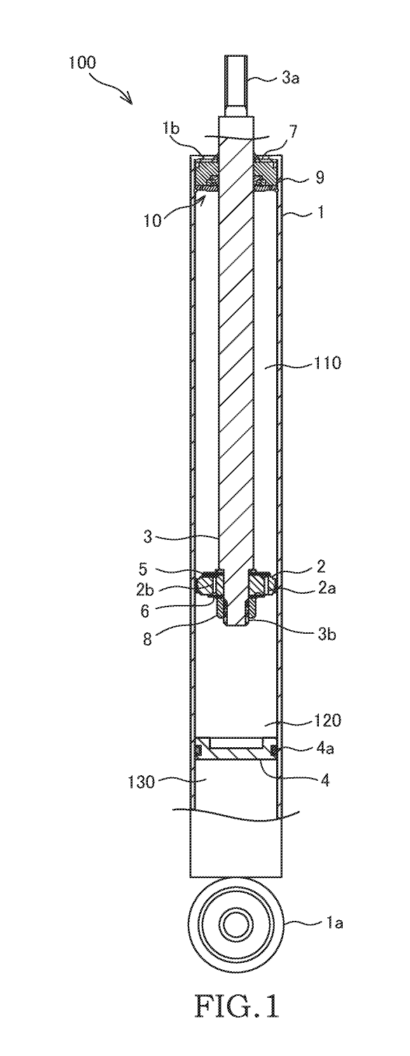

First, referring to FIGS. 1 and 4, a configuration of a shock absorber 100 according to this embodiment of the present invention will be described.

The shock absorber 100 is a device interposed between a body and an axle of a vehicle (not shown), for example, in order to suppress vibration of the body by generating damping force. As shown in FIG. 1, the shock absorber 100 includes a cylinder 1, an annular piston 2 that is provided inside the cylinder 1 to be free to slide and partitions the interior of the cylinder 1 into an extension-side chamber 110 and a contraction-side chamber 120, a piston rod 3 that is inserted into the cylinder 1 to be free to move in and out of the cylinder 1, and is coupled to the piston 2, and a rod guide 10 provided on one inside end portion (the upper end portion in FIG. 1) of the cylinder 1 so as to support the piston rod 3 to be free to slide. The extension-side chamber 110 and the contraction-side chamber 120 are fluid chambers in which working oil is sealed as a working fluid.

The shock absorber 100 is a mono-tube shock absorber having a free piston 4 that is inserted into the cylinder 1 to be free to slide and defines a gas chamber 130. A seal member 4a for keeping the gas chamber 130 airtight is provided on the outer periphery of the free piston 4.

A male screw 3a for attaching the shock absorber 100 to the vehicle is formed on an end portion of the piston rod 3 on the side that projects from the cylinder 1, and a male screw 3b having a nut 8 screwed thereto is formed on an end portion of the piston rod 3 on the side that is inserted into the cylinder 1.

The piston 2 includes passages 2a, 2b connecting the extension-side chamber 110 to the contraction-side chamber 120. A damping valve 5 including a plurality of annular leaf valves is provided on the extension-side chamber 110 side of the piston 2. Further, a damping valve 6 including a plurality of annular leaf valves is provided on the contraction-side chamber 120 side of the piston 2. The piston 2, the damping valve 5, and the damping valve 6 are fixed to the end portion of the piston rod 3 by the nut 8.

The damping valve 5 is opened by differential pressure generated between the extension-side chamber 110 and the contraction-side chamber 120 when the shock absorber 100 contracts, thereby opening the passage 2a, and applies resistance to a flow of working oil moving through the passage 2a from the contraction-side chamber 120 into the extension-side chamber 110. Further, when the shock absorber 100 extends, the damping valve 5 closes the passage 2a.

The damping valve 6 is opened when the shock absorber 100 extends, thereby opening the passage 2b, and applies resistance to a flow of working oil moving through the passage 2b from the extension-side chamber 110 into the contraction-side chamber 120. Further, when the shock absorber 100 contracts, the damping valve 6 closes the passage 2b.

In other words, the damping valve 5 serves as a damping force generating element when the shock absorber 100 contracts, while the damping valve 6 serves as a damping force generating element when the shock absorber 100 extends.

An axial direction position of the rod guide 10 is prescribed by causing the rod guide 10 to contact with a retaining ring 9 (a spring pin) that is provided on the inner peripheral surface of the cylinder 1 as a latching tool. The rod guide 10 will be described below.

A dust seal 7 is provided on the opposite side of the rod guide 10 to the extension-side chamber 110. The dust seal 7 prevents foreign matter from infiltrating the cylinder 1 by contacting and sliding around the outer peripheral surface of the piston rod 3. The dust seal 7 also prevents the working oil from leaking out from the outer periphery of a bearing 30 of the rod guide 10, to be described below, by contacting the inner peripheral surface of the cylinder 1.

The rod guide 10 and the dust seal 7 are fixed to the cylinder 1 by a caulked portion 1b caulked by bending the end portion of the cylinder 1 inwardly in the radial direction.

The end portion of the cylinder 1 on the gas chamber 130 side is closed by a cap member (not shown). Further, as shown in FIG. 1, a coupling member 1a for attaching the shock absorber 100 to the vehicle is provided on the gas chamber 130 side end portion of the cylinder 1. Instead of providing the cap member, the gas chamber 130 side end portion of the cylinder 1 may be closed by deformation processing.

When the shock absorber 100 contracts such that the piston rod 3 moves into the cylinder 1, the free piston 4 moves toward the gas chamber 130 side such that the gas in the gas chamber 130 is compressed by an amount corresponding to the volume by which the piston rod 3 has moved in. When the shock absorber 100 extends such that the piston rod 3 moves out of the cylinder 1, the free piston 4 moves to the contraction-side chamber 120 side such that the gas in the gas chamber 130 expands by an amount corresponding to the volume by which the piston rod 3 has moved out. Thus, volume change in the cylinder 1 is compensated for during an operation of the shock absorber 100.

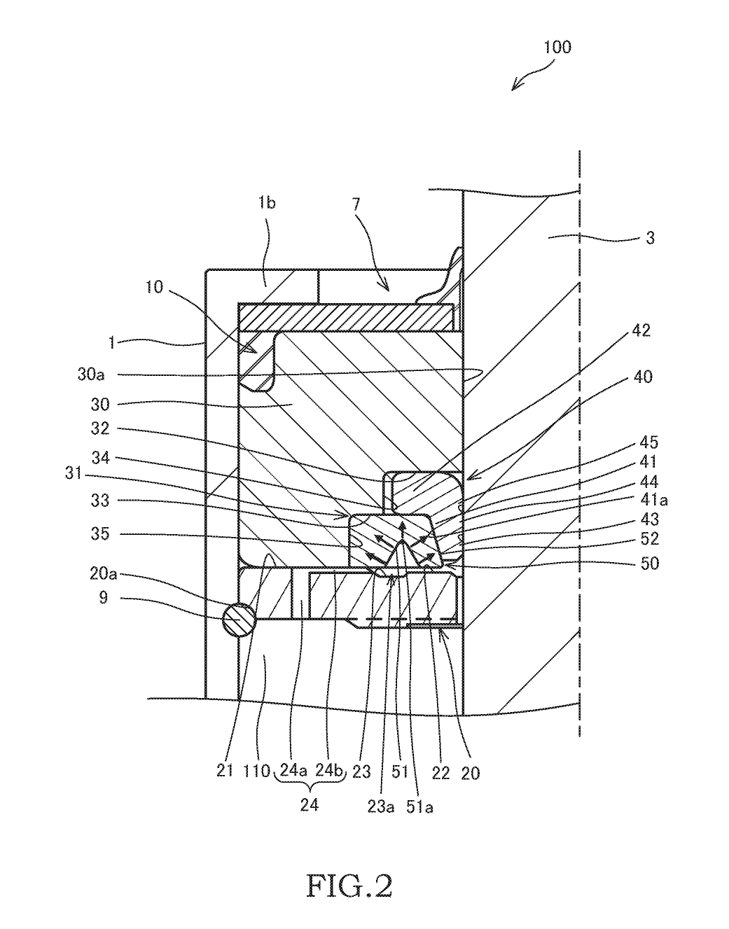

As shown in FIG. 2, the rod guide 10 includes a retainer 20 attached to the inner peripheral surface of the cylinder 1 so as to face the extension-side chamber 110, the bearing 30, which supports the piston rod 3 to be free to slide, a main seal 40 provided between the bearing 30 and the retainer 20, and a seal holder 50 that is provided on a radial direction outer side of the main seal 40 and has an annular recess 51 formed as a recessed portion in a surface thereof that opposes the retainer 20.

The retainer 20 has an annular latching groove 20a in an outer peripheral portion of a surface thereof that opposes the extension-side chamber 110. The retainer 20 is latched to the inner peripheral surface of the cylinder 1 by latching the latching groove 20a to the retaining ring 9.

The retainer 20 includes a contact portion 21 that contacts the seal holder 50 and a non-contact portion 22 that is separated from the seal holder 50 on an end surface thereof on the opposite side to the extension-side chamber 110 (an end surface on the bearing 30 side).

The contact portion 21 contacts the outer peripheral portion of the seal holder 50. The bearing 30 is provided in contact with the contact portion 21.

The non-contact portion 22 is separated from the inner peripheral portion of the seal holder 50 in the axial direction. An annular groove 23 defining an annular space 23a is formed in the non-contact portion 22.

A communicating passage 24 connecting the annular space 23a to the extension-side chamber 110 is formed in the retainer 20. The communicating passage 24 is constituted by a penetrating passage 24a that penetrates the retainer 20 in the axial direction, and a radial direction passage 24b that is formed on the end surface of the retainer 20 that opposes the bearing 30 so as to extend in the radial direction, and connects the penetrating passage 24a to the annular space 23a.

The bearing 30 is provided between the dust seal 7 and the retainer 20 in the axial direction so as to contact both the dust seal 7 and the retainer 20. The bearing 30 supports the piston rod 3, which passes through an insertion hole 30a, to be free to slide. The bearing 30 includes an accommodating recess 31 that defines an accommodating space for accommodating the main seal 40 and the seal holder 50 together with the retainer 20.

The accommodating recess 31 opens onto the insertion hole 30a and is opened in an end surface of the bearing 30 on the opposite side to the dust seal 7 (the end surface opposing the retainer 20). The accommodating recess 31 is formed from first and second bottom surfaces 32 and 33, which are perpendicular to a central axis, a first cylindrical surface 34 connecting the first and second bottom surfaces 32 and 33, and a second cylindrical surface 35 that is formed to be larger than the inner diameter of the first cylindrical surface 34 and connects the second bottom surface 33 to the end surface of the bearing 30. In other words, the accommodating recess 31 is formed in a step shape.

The second bottom surface 33 is provided further outward in the radial direction than the first bottom surface 32, and is separated from the first bottom surface 32 in the axial direction toward the retainer 20. The second bottom surface 33 serves as a support portion that contacts the seal holder 50 so as to support the seal holder 50 together with the retainer 20. The first bottom surface 32 contacts the main seal 40 so as to support the main seal 40 and the seal holder 50 together with the retainer 20.

The main seal 40 is formed from an elastic member that is deformed by external force. The main seal 40 includes a seal main body portion 41 that opposes the outer peripheral surface of the piston rod 3, and a flange portion 42 that extends outward in the radial direction from one end portion of the seal main body portion 41.

The seal main body portion 41 is formed in a tubular shape and disposed on the outer periphery of the piston rod 3. The flange portion 42 is formed to extend outward in the radial direction from an end portion of the seal main body portion 41 on the bearing 30 side (the upper end portion in FIG. 2). In other words, the main seal 40 is formed in a bent shape having a substantially L-shaped cross-section.

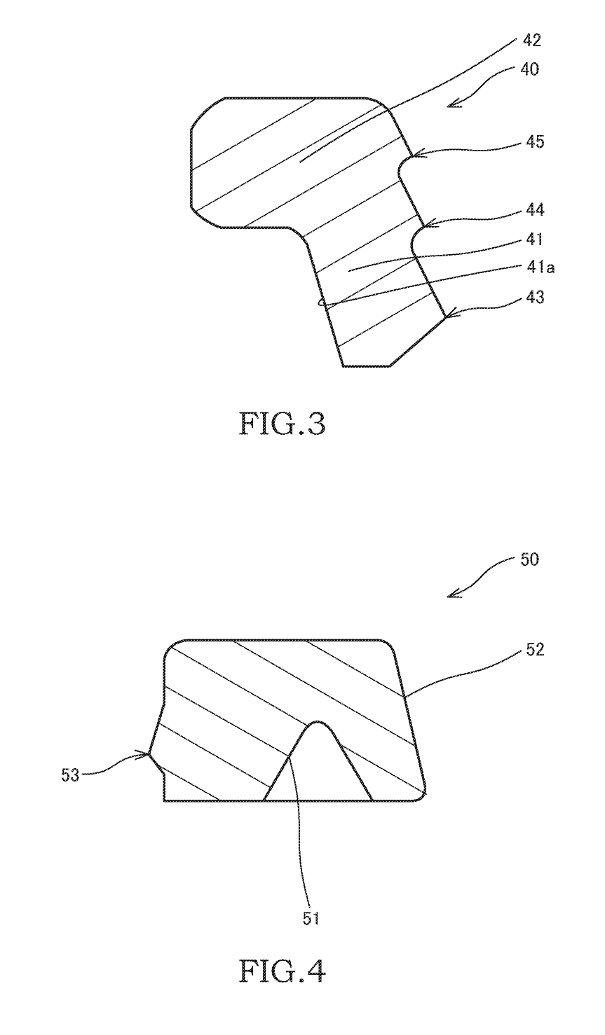

As shown in FIGS. 2 and 3, the seal main body portion 41 is provided with three lips that are formed to project inward in the radial direction from the inner peripheral surface thereof and pressed against the outer peripheral surface of the piston rod 3. Hereafter, the lip formed in the position closest to the retainer 20 will be referred to as a “main lip 43”, and the remaining two lips will be referred to as a “first sub-lip 44” and a “second sub-lip 45” in order from the main lip 43 toward the bearing 30.

The side face of the seal main body portion 41 on the opposite side to the piston rod 3 is formed as a tapered surface 41a that inclines toward the central axis of the piston rod 3. The seal main body portion 41 of the main seal 40 is separated from the non-contact portion 22 of the retainer 20 in the axial direction so as not to contact the non-contact portion 22. As a result, damage to the seal between the outer peripheral surface of the piston rod 3 and the inner peripheral surface of the seal main body portion 41 due to contact between the seal main body portion 41 and the retainer 20 is prevented.

The flange portion 42 is provided between the seal holder 50 and the first bottom surface 32 of the accommodating recess 31 in the bearing 30. Further, the flange portion 42 is separated from the first cylindrical surface 34 of the accommodating recess 31 in the radial direction. As a result, damage to the seal between the first bottom surface 31 of the accommodating recess 31 and the flange portion 42 due to contact between the first cylindrical surface 34 and the flange portion 42 is prevented.

The seal holder 50 is formed from an elastic member that is deformed by external force. An outer peripheral portion of the seal holder 50 is supported in the axial direction by the second bottom surface 33 of the accommodating recess 31 in the bearing 30 and the contact portion 21 of the retainer 20. An inner peripheral portion of the seal holder 50 is separated from the non-contact portion 22 of the retainer 20 in the axial direction. As a result, the retainer 20 is prevented from obstructing deformation of the seal holder 50.

Hence, the main seal 40 and the seal holder 50 are supported only by the bearing 30 and the retainer 20 and not actively compressed in the axial direction. It is sufficient for the main seal 40 and the seal holder 50 to be supported so that in a state where no differential pressure exists between the extension-side chamber 110 and the contraction-side chamber 120, or in other words a static state in which the shock absorber 100 is not performing an extension/contraction operation, no oil leakage occurs due to the internal pressure of the extension-side chamber 110.

The inner peripheral surface of the seal holder 50 is formed in a shape corresponding to the tapered surface 41a of the main seal 40, and is therefore formed as a contact surface 52 that contacts the tapered surface 41a from the radial direction outer side.

The annular recess 51 formed in the seal holder 50 is provided further toward the radial direction inner side than the second bottom surface 33 in a position facing the annular space 23a in the retainer 20. As a result, the working oil pressure in the extension-side chamber 110 is led into the annular recess 51 through the communicating passage 24 and the annular space 23a of the retainer 20. Further, a bottom portion (the most deeply recessed portion) 51a of the annular recess 51 is formed in an axial direction position that is further toward the bearing 30 side (the upper side in FIG. 2) than the main lip 43.

As shown in FIG. 4, the seal holder 50 is provided with an outside lip 53 that is formed to project from the outer peripheral surface thereof and pressed against the second cylindrical surface 35 of the accommodating recess 31 in the bearing 30.

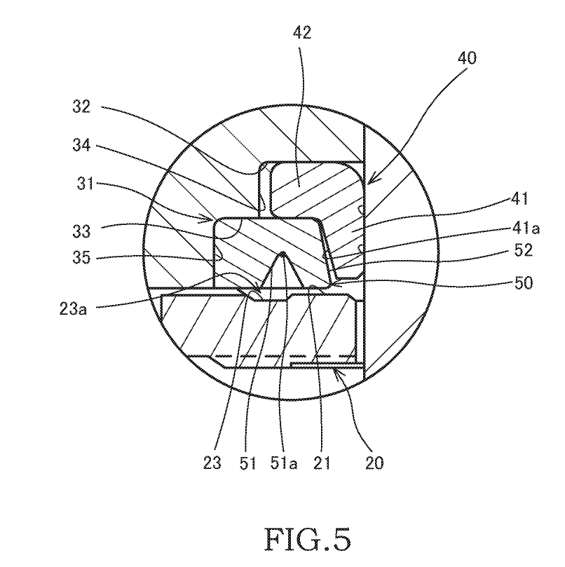

Next, referring mainly to FIGS. 2 and 5, a sealing structure realized by the main seal 40 and the seal holder 50 will be described more specifically.

In a state prior to the completion of assembly of the shock absorber 100, more specifically a state in which the rod guide 10 is accommodated in the cylinder 1 but no gas is sealed in the gas chamber 130 (see FIG. 1), no internal pressure is generated in the extension-side chamber 110. As shown in FIG. 5, in a state where no internal pressure is generated in the extension-side chamber 110, the contact surface 52 of the seal holder 50 is separated from, i.e. not in contact with, the tapered surface 41a of the main seal 40. It should be noted that a state in which no internal pressure is generated means a state in which the pressure in the gas chamber 130 does not act on the extension-side chamber 110 and the contraction-side chamber 120, or in other words a state in which the pressure in the extension-side chamber 110 is atmospheric pressure.

When gas is sealed into the gas chamber 130 from this state, the pressure of the gas acts on the extension-side chamber 110. Therefore, in the fully assembled shock absorber 100, internal pressure corresponding to the pressure in the gas chamber 130 is generated in the extension-side chamber 110.

When gas (nitrogen gas, for example) is sealed in the gas chamber 130 such that the pressure in the gas chamber 130 acts on the extension-side chamber 110, the internal pressure of the extension-side chamber 110 acts on the annular recess 51, causing the seal holder 50 to deform such that the contact surface 52 contacts the tapered surface 41a of the main seal 40. Hence, in a static state in which the shock absorber 100 does not perform an extension/contraction operation, or in other words a state in which no differential pressure exists between the extension-side chamber 110 and the contraction-side chamber 120, the contact surface 52 of the seal holder 50 receives the internal pressure of the extension-side chamber 110, the internal pressure being led to the annular recess 51, and thereby contacts with the tapered surface 41a of the main seal 40 (see FIG. 2).

As shown by the arrows in FIG. 2, as the shock absorber 100 performs an extension/contraction operation, the seal holder 50 is compressed in the axial direction in accordance with the working oil pressure led into the annular recess 51, whereby the seal holder 50 bulges out toward the radial direction inner and outer sides about the annular recess 51. Accordingly, the seal holder 50 pushes the main lip 43, the first sub-lip 44, and the second sub-lip 45 of the seal main body portion 41 of the main seal 40 toward the outer peripheral surface of the piston rod 3, and as a result, the outer peripheral surface of the piston rod 3 is sealed by the main seal 40. Moreover, simultaneously, the outside lip 53 of the seal holder 50 is pressed against the second cylindrical surface 35 of the accommodating recess 31 in the bearing 30, whereby the gap between the seal holder 50 and the bearing 30 is sealed.

Hence, in the shock absorber 100, the main seal 40 is pressed against the outer peripheral surface of the piston rod 3 by deforming the seal holder 50 using the working oil pressure led into the annular recess 51. By providing the shock absorber 100 with the seal holder 50 and forming the main seal 40 and the seal holder 50 from different materials, for example forming the main seal 40 from a highly durable material and forming the seal holder 50 from a material that exhibits superior elasticity even at low temperatures or the like, the sealing property of the rod guide 10 can be optimized.

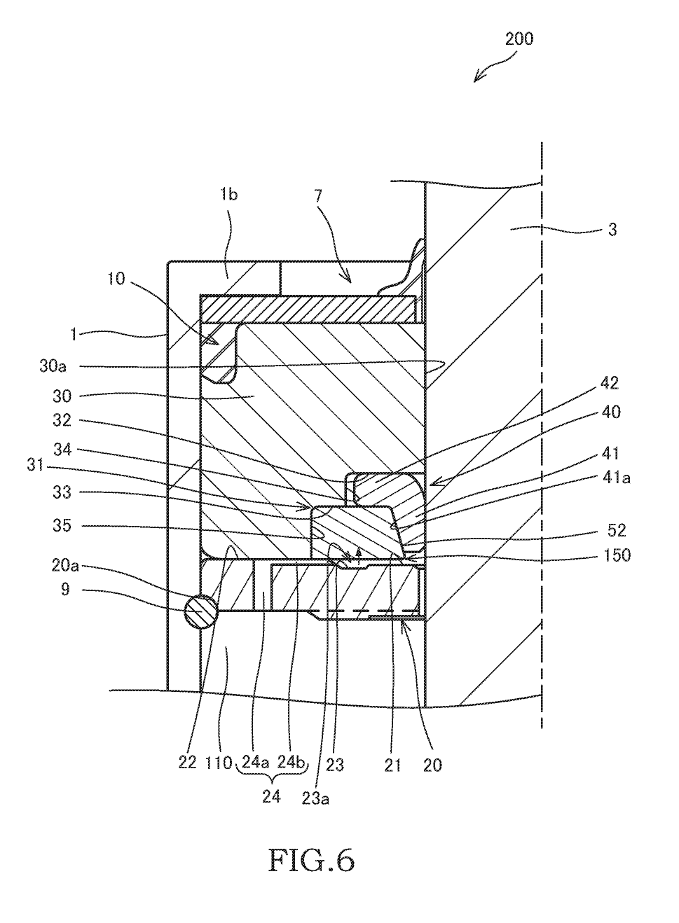

Here, to facilitate understanding of the present invention, a shock absorber 200 according to a comparative example of the present invention will be described with reference to FIG. 6. Identical configurations to the shock absorber 100 according to this embodiment have been allocated identical reference numerals, and description thereof has been omitted.

In the shock absorber 200 according to the comparative example, the annular recess 51 is not formed in a seal holder 150, and therefore working oil pressure acts on an end surface of the seal holder 150 that opposes the retainer 20. Accordingly, the seal holder 150 is compressed in the axial direction so as to bulge out in the radial direction, whereby the three lips of the main seal 40 are pressed against the outer peripheral surface of the piston rod 3. In other words, in the shock absorber 200, as shown by the arrow in FIG. 6, the pressure in the extension-side chamber 110 acts on the seal holder 150 only in the axial direction and not in the radial direction. As a result, the main seal 40 of the shock absorber 200 is pressed against the piston rod 3 when the pressure in the extension-side chamber 110, which acts in the axial direction, is converted to the radial direction by the deformation of the seal holder 150.

The pressure in the extension-side chamber 110 is derived from the extension/contraction operation of the shock absorber 200 and the pressure in the gas chamber 130. Hence, when the extension/contraction state of the shock absorber 200 varies, the pressure in the gas chamber 130 also varies, leading to variation in the pressure in the extension-side chamber 110. In the shock absorber 200, therefore, the pressure that acts on the end surface of the seal holder 150 varies in accordance with the extension/contraction state, and as a result, the pressing force exerted on the piston rod 3 by the main seal 40 may be insufficient.

In the shock absorber 100, on the other hand, the working oil pressure is led into the annular recess 51, and therefore the working oil pressure acts on the seal holder 50 in a perpendicular direction to the wall surface of the annular recess 51 such that force is exerted thereon in both the axial direction and the radial direction. Accordingly, as shown in FIG. 2, the seal holder 50 is caused to bulge out in the radial direction not only by being compressed in the axial direction but also by the pressure that acts directly thereon in the radial direction. In comparison with the shock absorber 200 in which the annular recess 51 is not formed, therefore, the surface area on which the working oil pressure is received increases, and the seal holder 50 is deformed more reliably in the radial direction by the force acting thereon in the radial direction. As a result, sufficient force for pressing the main seal 40 against the piston rod 3 can be secured even when the pressure in the extension-side chamber 110 varies.

Furthermore, when the bottom portion 51a of the annular recess 51 is positioned further toward the opposite side to the bearing 30 (the retainer 20 side) than the main lip 43, the working oil pressure may not be exerted sufficiently on the first sub-lip 44 and the second sub-lip 45, and as a result, the force for pressing the main lip 43 against the piston rod 3 may increase. In other words, an imbalance may occur in the pressing forces exerted respectively on the main lip 43, the first sub-lip 44, and the second sub-lip 45. In this case, the main lip 43 becomes worn more easily, leading to a reduction in the life of the main seal 40. Moreover, frictional force between the main seal 40 and the piston rod 3 increases, causing the sliding ability of the piston rod 3 to deteriorate.

In the shock absorber 100 according to this embodiment, however, the bottom portion 51a of the annular recess 51 is positioned further toward the bearing 30 side than the main lip 43. Therefore, concentrated exertion of the working oil pressure on the main lip 43 is suppressed, and balance is achieved in the forces by which the main lip 43, the first sub-lip 44, and the second sub-lip 45 are respectively pressed against the piston rod 3. As a result, the life of the main seal 40 can be extended and the sliding ability of the piston rod 3 can be improved.

Further, when the radial direction position of the annular recess 51 is set to overlap the second bottom surface 33 of the accommodating recess 31 in the bearing 30, or in other words when the annular recess 51 is positioned on the radial direction outer side of the first bottom surface 32, the second bottom surface 33 receives the working oil pressure led into the annular recess 51 such that the working oil pressure is less likely to act on the main seal 40. In the shock absorber 100, however, the radial direction position of the annular recess 51 is on the radial direction inner side of the second bottom surface 33, and therefore the working oil pressure is more likely to act on the main seal 40 through the seal holder 50. As a result, force for pressing the main seal 40 against the piston rod 3 can be secured more easily.

Furthermore, the seal holder 50 is not compressed by the bearing 30 and the retainer 20, and instead, the contact surface 52 thereof is brought into contact with the tapered surface 41a of the main seal 40 by the internal pressure of the extension-side chamber 110 in the static state. Therefore, when the shock absorber 100 is in the static state, the seal holder 50 receives almost no external force, and as a result, the amount of deformation therein from a natural state is extremely small. The seal holder 50 in this substantially natural state is more easily deformed by external force than when external force is exerted thereon in advance. The seal holder 50 can therefore be deformed easily when the working oil pressure in the extension-side chamber 110 acts on the annular recess 51 in response to the extension/contraction operation of the shock absorber 100, and as a result, the main seal 40 can be pressed against the piston rod 3.

Next, modified examples of this embodiment will be described.

In the above embodiment, as shown in FIG. 2, the annular recess 51 has a substantially triangular cross-section. However, the cross-sectional shape of the annular recess 51 is not limited thereto, and the annular recess 51 may be formed in any desired shape, such as a shape having a hemispherical cross-section or a substantially rectangular cross-section, as long as the desired sealing property is exhibited thereby.

Further, in the above embodiment, the single annular recess 51 formed in an annular shape is employed as the recessed portion. Instead, the recessed portion may be formed in a shape other than an annular shape or provided in a plurality. For example, a plurality of depressions or grooves may be formed as recessed portions in the end surface opposing the retainer 20.

Furthermore, in the above embodiment, three lips (the main lip 43, the first sub-lip 44, and the second sub-lip 45) are formed in the inner periphery of the main seal 40. Instead, one lip, two lips, four lips, or more may be formed in the inner periphery of the main seal 40. Moreover, although lips are preferably formed in the inner periphery of the main seal 40 to secure a sealing property more reliably, lips do not have to be formed.

Further, in the above embodiment, the annular recess 51 is provided on the radial direction inner side of the second bottom surface 33. To secure force for pressing the main seal against the piston rod, the respective radial direction positions of the annular recess 51 and the second bottom surface preferably do not overlap. However, the present invention is not limited thereto, and the radial direction position of the annular recess 51 may partially or entirely overlap (overlap when seen from the axial direction) the second bottom surface.

According to the embodiment described above, the following effects are obtained.

In the shock absorber 100, the working oil pressure is led into the annular recess 51, and therefore force acts on the seal holder 50 in both the axial direction and the radial direction. Accordingly, the seal holder 50 is caused to bulge out in the radial direction not only by being compressed in the axial direction but also by the force acting thereon in the radial direction. Hence, the seal holder 50 can be deformed more reliably in the radial direction so that the main seal 40 can be pressed against the piston rod 3. As a result, the sealing property of the shock absorber 100 can be improved.

Further, in the shock absorber 100, the bottom portion 51a of the annular recess 51 is positioned further toward the bearing 30 side than the main lip 43. Therefore, concentrated exertion of the working oil pressure on the main lip 43 is suppressed, and balance is achieved in the forces by which the main lip 43, the first sub-lip 44, and the second sub-lip 45 are respectively pressed against the piston rod 3. As a result, the life of the main seal 40 can be extended and the sliding ability of the piston rod 3 can be improved.

Furthermore, in the shock absorber 100, the radial direction position of the annular recess 51 is further toward the radial direction inner side than the second bottom surface 33, and therefore the working oil pressure is more likely to act on the main seal 40 through the seal holder 50. As a result, force for pressing the main seal 40 against the piston rod 3 can be secured more easily.

Moreover, when the shock absorber 100 is in the static state, the seal holder 50 is not compressed by the bearing 30 and the retainer 20, and instead, the contact surface 52 thereof is brought into contact with the tapered surface 41a of the main seal 40 by the internal pressure of the extension-side chamber 110. Hence, when the shock absorber 100 is in the static state, the seal holder 50 receives almost no external force, and as a result, the amount of deformation therein from the natural state is extremely small. The seal holder 50 can therefore be deformed easily when the working oil pressure in the extension-side chamber 110 acts on the annular recess 51 in response to the extension/contraction operation of the shock absorber 100, and as a result, the main seal 40 can be pressed against the piston rod 3.

Configurations, actions, and effects of the embodiments of the present invention will be summarized below.

The shock absorber 100 includes the cylinder 1 in which the working oil is sealed, the piston 2 that is provided inside the cylinder 1 to be free to slide and partitions the interior of the cylinder 1 into the extension-side chamber 110 and the contraction-side chamber 120, the piston rod 3 that is inserted into the cylinder 1 to be free to move in and out of the cylinder 1, and is coupled to the piston 2, and the rod guide 10 provided on the inside end portion of the cylinder 1 so as to support the piston rod 3 to be free to slide, wherein the rod guide 10 includes the retainer 20 attached to the inner peripheral surface of the cylinder 1 so as to face the extension-side chamber 110, the bearing 30 that supports the piston rod 3 to be free to slide, the main seal 40 provided between the bearing 30 and the retainer 20, and the seal holder 50 that is provided on the radial direction outer side of the main seal 40 and has the annular recess 51 formed in the surface thereof that opposes the retainer 20, and the seal holder 50 presses the main seal 40 against the outer peripheral surface of the piston rod 3 upon reception of the working oil pressure led into the annular recess 51 from the extension-side chamber 110.

Further, in the shock absorber 100, the main seal 40 is provided with the plurality of lips (the main lip 43, the first sub-lip 44, and the second sub-lip 45) that are formed to project from the inner peripheral surface thereof and pressed against the piston rod 3.

According to these configurations, the working oil pressure is led into the annular recess 51 such that force acts on the seal holder 50 in both the axial direction and the radial direction. Hence, the seal holder 50 is caused to bulge out in the radial direction not only by being compressed in the axial direction but also by the force acting thereon in the radial direction. The seal holder 50 is thus deformed more reliably in the radial direction so that the main seal 40 can be pressed against the piston rod 3. As a result, the sealing property of the shock absorber 100 is improved.

Further, in the shock absorber 100, the bottom portion 51a of the annular recess 51 is formed so as to be positioned further toward the bearing 30 side than the main lip 43 formed in the position closest to the retainer 20 among the plurality of lips.

According to this configuration, concentrated exertion of the working oil pressure on the main lip 43 is suppressed, and balance is achieved in the forces by which the main lip 43, the first sub-lip 44, and the second sub-lip 45 are respectively pressed against the piston rod 3. As a result, the life of the main seal 40 can be extended and the sliding ability of the piston rod 3 can be improved.

Furthermore, in the shock absorber 100, the bearing 30 includes the accommodating recess 31 that forms the accommodating space for accommodating the main seal 40 and the seal holder 50 opposite the retainer 20, the accommodating recess 31 includes the second bottom surface 33 for supporting the seal holder 50 together with the retainer 20, and the annular recess 51 is formed further toward the radial direction inner side than the second bottom surface 33.

According to this configuration, the working oil pressure led into the annular recess 51 is less likely to be received by the second bottom surface 33 and more likely to act on the main seal 40 through the seal holder 50. As a result, force for pressing the main seal 40 against the piston rod 3 can be secured more easily.

Moreover, in the shock absorber 100, the outside lip 53 that projects outward in the radial direction is formed on the outer peripheral surface of the seal holder 50.

According to this configuration, a seal can be formed between the seal holder 50 and the bearing 30.

Furthermore, in the shock absorber 100, in the static state in which no differential pressure exists between the extension-side chamber 110 and the contraction-side chamber 120, the seal holder 50 receives the internal pressure of the extension-side chamber 110, the internal pressure being led into the annular recess 51, so as to contact with the main seal 40.

According to this configuration, the contact surface 52 of the seal holder 50 is brought into contact with the tapered surface 41a of the main seal 40 by the internal pressure of the extension-side chamber 110 in the static state, and therefore, when the shock absorber 100 is in the static state, the seal holder 50 receives almost no external force. The seal holder 50 can therefore be deformed easily when the working oil pressure in the extension-side chamber 110 acts on the annular recess 51 in response to the extension/contraction operation of the shock absorber 100, and as a result, the main seal 40 can be pressed against the piston rod 3.

Embodiments of this invention were described above, but the above embodiments are merely examples of applications of this invention, and the technical scope of this invention is not limited to the specific constitutions of the above embodiments.

This application claims priority based on Japanese Patent Application No. 2016-182855 filed with the Japan Patent Office on Sep. 20, 2016, the entire contents of which are incorporated into this specification.

1. A shock absorber comprising:
a cylinder in which a working fluid is sealed;
a piston provided inside the cylinder to be free to slide, the piston being configured to partition the interior of the cylinder into an extension-side chamber and a contraction-side chamber;
a piston rod inserted into the cylinder to be free to move in and out of the cylinder, the piston rod being coupled to the piston; and
a rod guide provided on an inside end portion of the cylinder so as to support the piston rod to be free to slide,
wherein the rod guide comprises:
a retainer attached to an inner peripheral surface of the cylinder so as to face the extension-side chamber;
a bearing configured to support the piston rod to be free to slide;
a main seal provided between the bearing and the retainer; and
a seal holder provided on a radial direction outer side of the main seal, the seal holder having a recessed portion formed in a surface thereof that opposes the retainer, and
the seal holder presses the main seal against an outer peripheral surface of the piston rod upon reception of working fluid pressure that is led into the recessed portion from the extension-side chamber.

2. The shock absorber as defined in claim 1, wherein the main seal is provided with a plurality of lips that are formed to project from an inner peripheral surface thereof and configured to press against the piston rod.

3. The shock absorber as defined in claim 2, wherein a bottom portion of the recessed portion is positioned further toward the bearing side than a main lip that is formed in a position closest to the retainer among the plurality of lips.

4. The shock absorber as defined in claim 1, wherein the bearing includes an accommodating recessed portion that forms an accommodating space together with the retainer, the accommodating space being configured to accommodate the main seal and the seal holder,
the accommodating recessed portion includes a support portion configured to support the seal holder together with the retainer, and
the recessed portion is formed further toward a radial direction inner side than the support portion.

5. The shock absorber as defined in claim 1, wherein an outside lip that projects outward in the radial direction is formed on an outer peripheral surface of the seal holder.

6. The shock absorber as defined in claim 1, wherein, in a static state in which no differential pressure exists between the extension-side chamber and the contraction-side chamber, the seal holder receives an internal pressure of the extension-side chamber, the internal pressure being led to the recessed portion, so as to contact with the main seal.

7. The shock absorber as defined in claim 4, wherein an outside lip that projects outward in the radial direction is formed on an outer peripheral surface of the seal holder, and
in a static state in which no differential pressure exists between the extension-side chamber and the contraction-side chamber, the seal holder receives an internal pressure of the extension-side chamber, the internal pressure being led to the recessed portion, so as to contact with the main seal.
